(19) United States
(12) Patent Application Publication
(10) Pub. No.: US 2022/0253877 A1
(43) Pub. Date: Aug. 11, 2022

(54) METHOD FOR DETERMINING AT LEAST ONE EVALUATED COMPLETE ITEM OF AT LEAST ONE PRODUCT SOLUTION

(71) Applicant: SIEMENS AKTIENGESELLSCHAFT, München (DE)

(72) Inventors: Marcel Hildebrandt, München (DE); Serghei Mogoreanu, München (DE); Swathi Shyam Sunder, München (DE); Ingo Thon, Grasbrunn (DE)

(21) Appl. No.: 17/628,214

(22) PCT Filed: Jul. 19, 2019
(86) PCT No.: PCT/EP2019/069563

§ 371 Date: Jan. 18, 2022

(51) Int. Cl. G06Q 30/02

(52) U.S. Cl. CPC G06Q 30/0206; G06Q 30/0282; G06Q 30/0201

(57) ABSTRACT

The invention is directed to a computer-implemented method for determining at least one completed item of at least one product solution, comprising the steps of: a. Providing at least one input data set with at least one partial item of the at least one product solution; wherein b. the at least one partial item comprises at least one initial feature; c. Complementing the at least one partial item of the at least one product solution with at least one additional alternative feature using a trained machine learning model on the basis of at least one partial item of the at least one product solution to determine a plurality of alternative complete items of the at least one product solution; and d. Determining at least one evaluated complete item of the plurality of alternative items of the at least one product solution as output data set using a market impact evaluation. Further, the invention relates to a corresponding computer program product and system.

This application is the National Stage of International Application No. PCT/EP2019/069563, filed Jul. 19, 2019. The entire contents of this document are hereby incorporated herein by reference.

### BACKGROUND

### 1. Technical Field

The present embodiments relate to a computer-implemented method for determining at least one evaluated complete item of at least one product solution, and a corresponding computer program product and product recommendation system.

### 2. Prior Art

In manufacturing companies, it is quite crucial to constantly evaluate the product portfolio and extend the product portfolio with new products. A number of approaches for designing new products are known from the prior art.

According to a first approach, a product may be manually designed from scratch. However, this is a brute-force approach that would require trying out a number of possible combinations of features and comparing the possible solutions against existing products.

According to a second approach, engineers who are responsible for designing products start with a set of requirements (e.g., specifications requested by a customer for a product) and extend the set of requirements by completing the missing feature specifications.

The disadvantage of the known approaches is that the known approaches rely on domain expertise. The design process involves a group of engineers gathering together and discussing what new products would bring value to the company, also referred to as market impact. The determination of the market impact requires information about target markets and customers. According to this, a separate marketing team may also be necessary. Thus, the known approaches are cost intensive, time-consuming, and error-prone.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a computer-implemented method for determining at least one evaluated complete item of at least one product solution in an efficient and reliable manner considering the potential market impact is provided.

According to one aspect, a computer-implemented method for determining at least one evaluated complete item of at least one product solution includes providing at least one input data set with at least one partial item of the at least one product solution. The at least one partial item includes at least one initial feature. The computer-implemented method includes complementing the at least one partial item of the at least one product solution with at least one additional alternative feature using a trained machine learning model based on at least one partial item of the at least one product solution to determine a plurality of alternative complete items of the at least one product solution. At least one evaluated complete item of the plurality of alternative complete items of the at least one product solution is determined as an output data set using a market impact evaluation.

Accordingly, the present embodiments include a method for determining one or more evaluated complete items of one or more product solutions. The item may be equally referred to as a single product. Thereby, one product solution or solution may include a plurality of items. For example, solution 1 includes, for example, item 1, item 2, and item 3.

The final product solution includes a plurality of items that together fulfill some requirements (e.g., one company selecting controllers, motors, and conveyor belts of another company to build a production plant).

In a first act, the input data set is received. The input data set includes one or more partial items. Thereby, one partial item includes one or more initial or partial features (e.g., technical features). The input data set may be considered as partial specification, initial product solution/design, or, more specifically, constraints for the design of the new product solution. For example, item 1, item 2, and item 3 each include three features (e.g., type, size, and voltage). According to this, the product solution may be a device, such as a car, and the corresponding initial item may be an engine or type.

In a further act, the complete item is determined using machine learning based on the partial item. In this act, the initial feature of the partial item is extended by additional or further alternative features to generate the complete item. The complete item thus includes the initial and additional features.

Referring to the example, the partial item with one initial feature “type” is extended with the additional features “size” and “voltage”. Accordingly, not just the additional feature “voltage” may be determined, but also the value of this feature (e.g., 25 V).

Therefore, a trained machine learning model or predictor is applied using machine learning during throughput.

To the contrary, in the training phase, a set of independent input data sets is used as a training data set to train the machine learning model (e.g., a learner). The machine learning model is a generative model in one embodiment.

Thus, in other words, the machine learning model is untrained and used in the training process with a training input data set, whereas the trained machine learning model is used after training in the running system or for the method according to the present embodiments. The training data set includes a plurality of historical product solutions. Each historical product solution of the plurality of historical product solutions includes at least one historical item and a plurality of corresponding items with respective features. In other words, the historical product solutions includes real, existing items and corresponding technical features.

The method according to the present embodiments provides an improved efficiency and accuracy in determining the evaluated complete item. The evaluated complete item and, in the end, the product solution are more reliable compared to prior art.

Considering autonomous driving and the according autonomous cars as final product solutions, the safety of the operator and car may be significantly increased. Accidents may be prevented from the very beginning taking the needs of the operator into account.

More precisely, the advantage is that the method enables the complementation or completion of feature specifications for a partial product in an efficient and reliable manner. Further, the method provides that the resulting new and complete product maximizes the market impact and thus satisfies the requirements of the customers.

The disadvantages of the expensive and time-consuming design process of new products solely based on domain knowledge of engineers and market research according to prior art may be overcome. In one aspect, the machine learning model is a generative model, selected from the group, including generative adversarial network (GAN) and sequential neural network. Thus, the method may be applied in a flexible manner according to the specific application case, underlying technical system, and user requirements. These networks have proven to be advantageous since the networks provide high reliability in determining the item, may be trained flexibly, and offer fast evaluation.

In another aspect the market impact evaluation comprises the steps of—Determining at least one respective market impact factor for each alternative complete item of the at least one product solution by evaluating the at least one product solution using a relational recommendation system based on the at least one initial feature and at least one alternative feature of the alternative complete item and a plurality of historical product solutions; wherein each historical product solution of the plurality of historical product solutions comprises at least one historical item and—Ranking the plurality of alternative complete items de pending on the respective market impact factors; and—Determining at least one evaluated complete item of the at least one product solution with the highest or lowest impact factor of the ranked plurality of alternative complete items.

In another aspect, the market impact factor includes a number of orders of the at least one product solution, a confidence of the at least one product solution, or a revenue with the at least one product solution. Accordingly, diverse market impact factors may be considered. Thus, the method may be applied in a flexible manner according to the specific application case, underlying technical system, and customer or product segment. Accordingly, each alternative complete item of the product solution is assigned to a respective market impact factor.

The impact factor may depend on the underlying manufacturing system and/or customer. The market impact factors are ranked. The evaluated complete item is selected from the alternative complete items considering the ranking results. The associated product solution of the evaluated complete item is the best product solution in view of the market impact and may be added to the product portfolio of the company.

In another aspect, the method further includes the act of performing at least one action.

In another aspect, the at least one action is outputting the at least one input data set, data of intermediate method acts, the output data set, and/or any other related notification, storing the at least one input data set, data of inter mediate method steps, the output data set, and/or any other related notification, displaying the at least one input data set, data of intermediate method acts, the output data set, and/or any other related notification, or transmitting the at least one input data set, data of intermediate method acts, the output data set, and/or any other related notification to a computing unit for further processing.

Accordingly, the input data, data of intermediate method acts, and/or resulting output data may be further handled.

One or more actions may be performed. The action may be equally referred to as measure. These actions may be performed by one or more computing units of the system. The actions may be performed gradually or simultaneously. Actions include, for example, storing and processing acts. The advantage is that appropriate actions may be performed in a timely manner.

For example, a notification related to the evaluated complete item with the market impact factor may be outputted and/or displayed to a user (e.g., customer) by a display unit (e.g., the complete item with the highest market impact factor or complete items with market impact factors exceeding a predetermined threshold).

A further aspect of the invention is a computer program product directly loadable into an internal memory of a computer, comprising software code portions for performing the steps according to any one of the preceding claims when said computer program product is running on a computer.

A further aspect of is a product recommendation system for determining at least one evaluated completed item of at least one product solution. The product recommendation system includes a receiving unit for providing at least one input data set with at least one partial item of the at least one product solution. The at least one partial item includes at least one initial feature. The product recommendation system also includes a complementing unit for complementing the at least one partial item of the at least one product solution with at least one additional alternative feature using a trained machine learning model based on at least one partial item of the at least one product solution to determine a plurality of alternative complete items of the at least one product solution. The product recommendation system also includes a determining unit for determining at least one evaluated complete item of the plurality of alternative complete items of the at least one product solution as an output data set depending on a market impact evaluation.

The units may be realized as any devices, or any means, for computing (e.g., for executing a software, an app, or an algorithm). For example, the receiving unit and/or the determining unit may include a central processing unit (CPU) and/or a memory operatively connected to the CPU. The units may also include an array of CPUs, an array of graphical processing units (GPUs), at least one application-specific integrated circuit (ASIC), at least one field-programmable gate array, or any combination of the foregoing. The units may include at least one module that may include software and/or hardware. Some, or even all, modules of the units may be implemented by a cloud computing platform.

### BRIEF DESCRIPTION OF THE DRAWINGS

FIG. 1 illustrates a flowchart of one embodiment of a method; and

FIG. 2 illustrates a relational recommendation system according to an embodiment.

### DETAILED DESCRIPTION

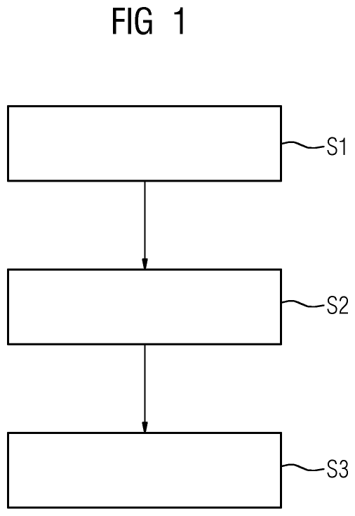

FIG. 1 illustrates a flowchart of one embodiment of a method with the method acts S1 to S3. The method acts S1 to S3 will be explained in the following in more detail.

### Input Data Set

First, the input data set is received S1. The input data set includes a partial item 20 with an initial feature of a product solution. The features 22, 24 may be technical features and/or requirements for the product solution 10. This input data set may be provided in the form of a feature request by a potential customer or may be partially derived from existing products in the product portfolio.

### Machine Learning Model

A generative model, such as a generative adversarial network (GAN) (e.g., graph-based) or a sequential neural network is trained on the historical shopping data A and technical information of items B, resulting in a trained machine learning model.

The trained machine learning model is used in act S2. The trained machine learning model takes the input data set from act S1 as input and transforms the input data into one or more alternative complete items and associated complete product solutions in act S2. In other words, the trained machine learning model automatically selects additional alternative features 24 that complement the initial features 22 of the partial item 20 of the product solution. This way, the partial or initial item 20 and associated product solution 10 is complemented, resulting in alternative complete items for the product solution.

### Relational Recommendation System

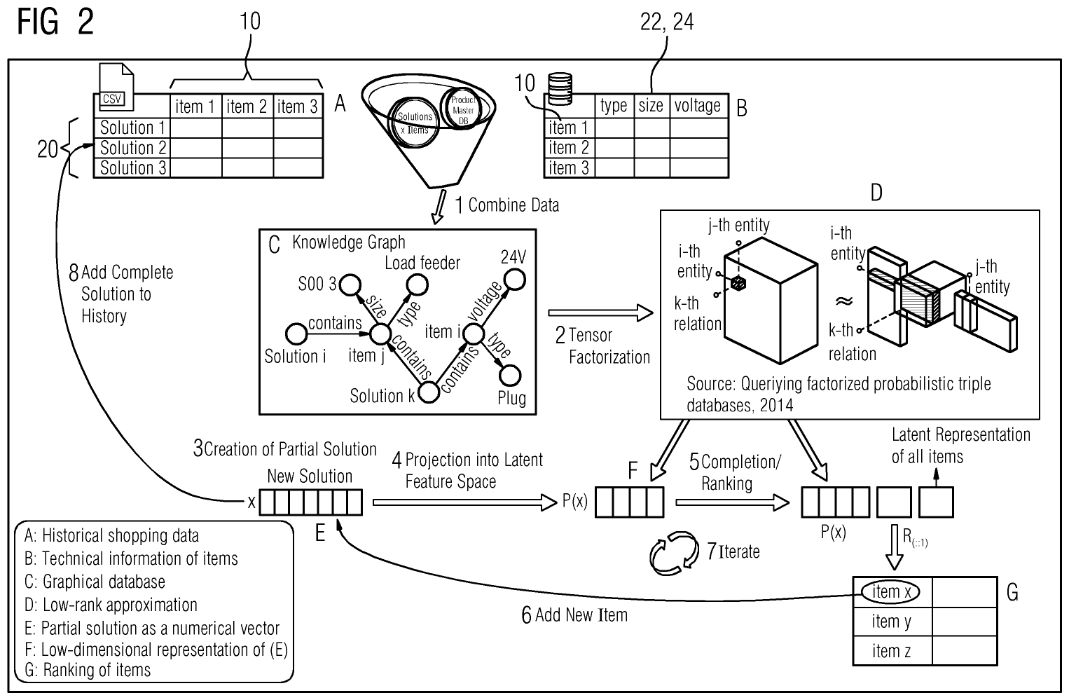

Once the alternative complete items are determined, the alternative complete items are to be evaluated in view of the market impact. Therefore, the relational recommendation system according to FIG. 2 is used. This relational recommendation system uses the historical shopping data A and the technical information of items B according to FIG. 2 to automatically evaluate a potential product solution. The acts of the evaluation are explained in more detail in the following with regard to FIG. 2.

For each product solution (e.g., Solution 1, Solution 2, Solution 3) in the historical shopping data A that contains an item 20 from the same product category as the new product solution 10, this item 20 is masked to generate the masked historical shopping data.

The pseudocode may be as follows:

masked_solutions = [ ]
removed_items = [ ]
category = get_category(proposed_item)
for i, solution in enumerate (solutions):
item_indices_to_remove = [ ]
for j, item in enumerate (solution):
if get_category(item) == category:
masked_solutions.append(item)
item_indices_to_remove.append(j)
removed_items.append(item)
solutions[i] = [solution [k] for k in range (len (solution)) if k not
in item_indices_to_remove]

Further, the market impact is evaluated for each alternative complete item or product specification based on the masked historical shopping data in act S3.

Therefore, for each entry or marked alternative complete item in the masked historical shopping data, the relational recommendation system is used to recommend a replacement of the marked alternative complete item.

This replacement act may be performed twice: once with the potential product solution being known or historical product solution to the recommendation system, and once with the potential product solution not taken into consideration.

This way it may be estimated for how many previously configured product solutions, the determined product solution would have made sense, potentially even more sense than the existing product solution that the user has bought.

This act allows the number of customers that would benefit from the newly determined product solution to be estimated.

The pseudocode may be as follows:

count = 0
for i in range (len(masked_solutions)):
solution = masked_solutions[i]
removed_item = removed_items[i]
item_1 = recommend_knowing_new_product (solution, removed_item)
item_2 = recommend_not_knowing_new_product (solution,
removed_item)
if (item_1 == proposed_item) and (item_2 == removed_item) :
count += 1

Next, the alternative complete items may be ranked depending on the evaluation criteria or market impact factors. The new product with the highest market impact (e.g., the new product that would have impacted the maximum number of orders, with a high confidence) is proposed as a recommendation to be added to the product portfolio of the company and/or to be further handled.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A computer-implemented method for determining at least one evaluated complete item of at least one product solution, the computer-implemented method comprising the steps of:
providing fat least one input data set with at least one partial item of the at least one product solution, wherein the at least one partial item comprises at least one initial feature;
complementing the at least one partial item of the at least one product solution with at least one additional alternative feature using a trained machine learning model based on at least one partial item of the at least one product solution, such that a plurality of alternative complete items of the at least one product solution are determined; and
determining at least one evaluated complete item of the plurality of alternative complete items of the at least one product solution has an output data set depending on a market impact evaluation.

2. The computer-implemented method of claim 1, wherein the machine learning model is a generative model, the generative model being a generative adversarial network (GAN) or sequential neural network.

3. The computer-implemented method of claim 1, wherein the market impact evaluation comprises:
determining at least one respective market impact factor for each alternative complete item of the at least one product solution, the determining of the at least one respective market impact factor comprising evaluating the at least one product solution using a relational recommendation system based on the at least one initial feature and at least one additional alternative feature of the alternative complete item and a plurality of historical product solutions, wherein each historical product solution of the plurality of historical product solutions comprises at least one historical item;
ranking the plurality of alternative complete items depending on the respective market impact factors; and
determining at least one evaluated complete item of the at least one product solution with a highest impact factor or a lowest impact factor of the ranked plurality of alternative complete items.

4. The computer-implemented method of claim 1, wherein the market impact factor is a number of orders of the at least one product solution, a confidence of the at least one product solution, or a revenue With the at least one product solution.

5. The computer-implemented method of claim 1, further comprising performing at least one action.

6. The computer-implemented method of claim 5, wherein the at least one action comprises:
outputting the at least one input data set, data of intermediate method steps, the output data set, another related notification, or any combination thereof;
storing the at least one input data set, the data of intermediate method steps, the output data set, the other related notification, or any combination thereof;
displaying the at least one input data set, the data of intermediate method steps, the output data set, the other related notification or any combination thereof;
transmitting the at least one input data set, the data of intermediate method steps, the output data set, the other related notification, or any combination thereof to a computing unit for further processing; or any combination thereof.

7. (canceled)

8. A product recommendation systems for determining at least one completed item of at least one product solution, the product recommendation system comprising:
a receiving unit configured to provide at east one input data set with at least one partial item of the at least one product solution, wherein the at least one partial item comprises at least one initial feature;
a complementing unit configured to complement the at least one partial item of the at least one product solution with at least one additional alternative feature using a trained machine learning model based on at least one partial item of the at least one product solution, such that a plurality of alternative complete items of the at least one product solution are determined; and
determining unit configured to determine at least one evaluated complete item of the plurality of alternative complete items of the at least one product solution as an output data set depending on a market impact evaluation.

9. In a non-transitory computer-readable storage medium that stores instructions executable by one or more processors to determine at least one evaluated complete item of at least one product solution, the instructions comprising:
providing at least one input data set with at least one partial item of the at least one product solution, wherein the at least one partial item comprises at least one initial feature;
complementing the at least one partial item of the at least one product solution with at least one additional alternative feature using a trained machine learning model based on at least one partial item of the at least one product solution, such that a plurality of alternative complete items of the at least one product solution are determined; and
determining at least one evaluated complete item of the plurality of alternative complete items of the at least one product solution as an output data set depending on a market impact evaluation.

10. The non-transitory computer-readable storage medium of claim 9, wherein the machine learning model is a generative model, the generative model being a generative adversarial network (GAN) or sequential neural network.

11. The non-transitory computer-readable storage medium of claim 9, wherein the market impact evaluation comprises:
determining at least one respective market impact factor for each alternative complete item of the at least one product solution, the determining of the at least one respective market impact factor comprising evaluating the at least one product solution using a relational recommendation system based on the at least one initial feature and at least one additional alternative feature of the alternative complete item and a plurality of historical product solutions, wherein each historical product solution of the plurality of historical product solutions comprises at least one historical item;
ranking the plurality of alternative complete items depending on the respective market impact factors; and
determining at least one evaluated complete item of the at least one product solution with a highest impact factor or a lowest impact factor of the ranked plurality of alternative complete items.

12. The non-transitory computer-readable storage medium of claim 9, wherein the market impact factor is a number of orders of the at least one product solution, a confidence of the at least one product solution, or a revenue with the at least one product solution.

13. The non-transitory computer-readable storage medium of claim 9, wherein the instructions further comprise performing at least one action.

14. The computer-implemented method of claim 13, wherein the at least one action comprises:
outputting the at least one input data set, data of intermediate method steps, the output data set, another related notification, or any combination thereof;
storing the at least one input data set, the data of intermediate method steps, the output data set, the other related notification, or any combination thereof;
displaying the at least one input data set, the data of intermediate method steps, the output data set, the other related notification, or any combination thereof;
transmitting the at least one input data set, the data of intermediate method steps, the output data set, the other related notification, or any combination thereof to a computing unit for further processing; or
any combination thereof.
